(19) United States
(12) Patent Application Publication
(10) Pub. No.: US 2006/0254805 A1
(43) Pub. Date: Nov. 16, 2006

(54) Low profile high speed transmission cable

(75) Inventors: Richard J. Scherer, Austin, TX (US); Denis D. Springer, Leander, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/137,286

(22) Filed: May 25, 2005

(51) Int. Cl. H01B 5/08

(52) U.S. Cl. 174/129 R

(57) ABSTRACT

A low profile transmission cable for high frequency applications includes one or more inner conductors each having a substantially oblong curvilinear cross-section. A dielectric material generally surrounds the one or more inner conductors. A metallic outer shield generally surrounds the dielectric material. An outer jacket envelops the metallic outer shield.

### FIELD

The present invention relates to transmission cables. In particular, the present invention relates to a low profile transmission cable including a substantially oblong shaped conductor.

### BACKGROUND

Cables for transmitting electrical signals are widely known and have come into extensive commercial use. Examples of such cables include coaxial and twinaxial cables. Coaxial cables basically consist of a signal conductor and a metallic outer shield separated from the inner conductor by a dielectric material. Twinaxial cables basically consist of two signal conductors each surrounded by a dielectric material, which separates the conductors from a common metallic shield.

For many coaxial and twinaxial applications, achieving high signal propagation speed with less susceptibility to signal loss and distortion is a critical requirement. Examples of such applications include low-loss UHF/microwave interconnect cable, wireless telephony base station interconnect cable, semiconductor device testing equipment, instrumentation systems, computer networking, data communications, and broadcasting cable. Using larger conductors reduces cable attenuation, but to keep overall cable size small, low dielectric constant components are necessary.

High propagation speed coaxial and twinaxial cables of the prior art have used a variety of designs. In general, designers want to use as large an inner conductor diameter as possible since signal loss varies inversely with increasing conductor diameter. In addition, as signal frequency increases, the resistance of the conductor increases due to skin effect. Skin effect describes a condition where, due to magnetic fields produced by current flowing through the conductor, there is a concentration of current near the conductor surface. As the frequency increases, the current is concentrated closer to the surface. This effectively decreases the cross-section through which current flows, and therefore increases the effective resistance. Thus, a larger inner conductor, with a corresponding larger surface area, conducts more current in high frequency applications.

Larger inner conductor diameter sizes typically require larger volumes of dielectric surrounding the conductor to maintain desired cable impedance. This not only increases the overall size of the cable, but also prevents the cable from being used with standard micro-connectors used in high frequency systems. One common solution to the latter issue is to use paddleboards or reducing couplers to facilitate transition from a larger inner conductor to a smaller inner conductor that engages the connector. While this allows standard micro-connectors to be used, electrical performance is sacrificed through the transition device. Another common solution is to offset the increased size of the inner conductor or conductors with a smaller dielectric having a lower overall dielectric constant value for the interior space separating the inner conductor or conductors from the metallic shield. However, this approach tends to cause current bunching between the inner conductor and the metallic shield. Also, in the case of a twinaxial cable, current bunching tends to occur between the adjacent inner conductors. This results in a non-uniform distribution of current flowing through the conductor or conductors, which causes an increase in resistance since less of the conductor is being used to conduct current.

### SUMMARY

In a first aspect, the present invention is a low profile transmission cable for high frequency applications. The transmission cable includes one or more inner conductors each having a substantially oblong curvilinear cross-section. A dielectric material generally surrounds the one or more inner conductors. A metallic outer shield generally surrounds the dielectric material. An outer jacket envelops the metallic outer shield.

In a second aspect, the present invention is a low profile transmission cable suitable for transmission of signals in excess of 100 MHz. The transmission cable includes a first conductor having a first substantially oblong cross-section. A first dielectric sheath generally surrounds the first conductor. A metallic outer shield generally surrounds the dielectric sheath. An outer jacket envelops the metallic outer shield.

The above summary is not intended to describe each disclosed embodiment or every implementation of the present invention. The figures and the detailed description which follow more particularly exemplify illustrative embodiments.

### BRIEF DESCRIPTION OF THE DRAWINGS

FIG. 1 is a partial sectional side perspective view of a coaxial cable according to an embodiment of the present invention.

FIG. 2 is a cross-sectional view of the cable shown in FIG. 1, as taken along lines 2-2 in FIG. 1.

FIG. 3 is a cross-sectional view of a coaxial cable including a drain wire, according to another embodiment of the present invention.

FIG. 4 is a cross-sectional view of a twinaxial cable according to another embodiment of the present invention, including a unitary dielectric surrounding the conductors.

FIG. 5 is a cross-sectional view of a twinaxial cable according to another embodiment of the present invention, including a drain wire and a dielectric sheath wrapped around the conductors.

The above-identified drawing figures set forth several embodiments of the invention. Other embodiments are also contemplated, as noted in the discussion. In all cases, this disclosure presents the invention by way of representation and not limitation. It should be understood that numerous other modifications and embodiments can be devised by those skilled in the art which fall within the scope and spirit of the principals of this invention. The figures may not be drawn to scale. Like reference numbers have been used throughout the figures to denote like parts.

### DETAILED DESCRIPTION

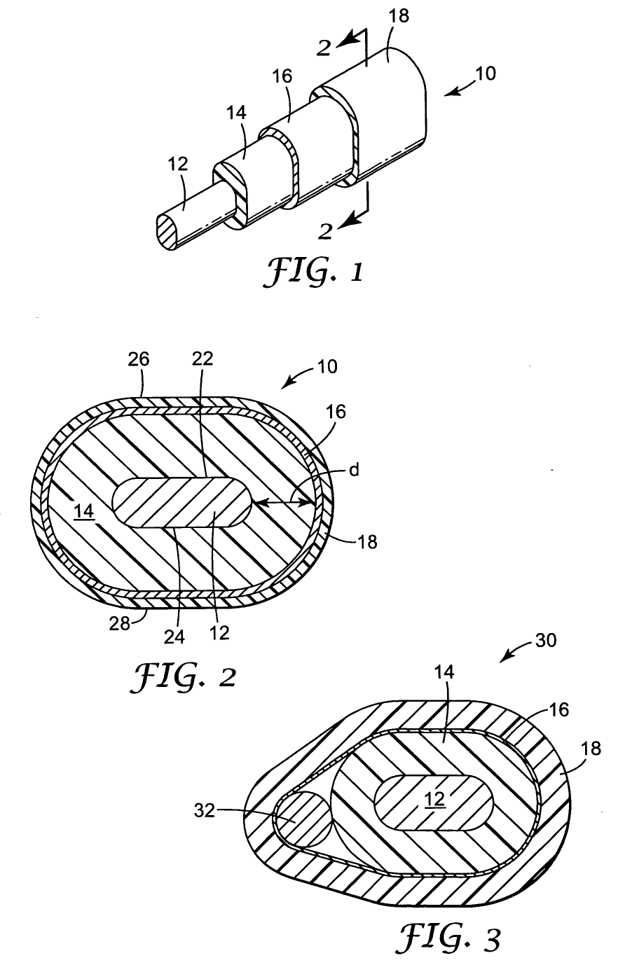

FIG. 1 is a partial sectional side perspective view and FIG. 2 is a cross-sectional view of coaxial cable 10 according to an embodiment of the present invention. Coaxial cable 10 includes conductor 12, dielectric sheath 14, metallic shield 16, and jacket 18. Dielectric sheath 14 is formed around conductor 12 so as to generally surround conductor 12. Metallic shield 16 is formed around dielectric sheath 14 so as to generally surround dielectric sheath 14. Jacket 18 envelops metallic shield 16 to form an outer protective casing for coaxial cable 10.

Conductor 12 may be made of a various conductive materials, including bare copper, tinned copper, copper-covered steel, or aluminum. Also, conductor 12 may be either a stranded or a solid element. In the case of a stranded element, conductor 12 is made of a plurality of electrically engaged conductive strands.

Coaxial cable 10 is used in high frequency signal applications, such as those greater than 100 MHz. As described above, as signal frequency increases, the resistance of a conductor increases due to skin effect. Skin effect describes a condition where, due to magnetic fields produced by current flowing through the conductor, there is a concentration of current near the conductor surface. To maximize the surface area at the conductor surface, conductor 12 has a substantially oblong curvilinear cross-section. A substantially oblong curvilinear cross-section includes any elongated shape having rounded sides including, but not limited to, ovate, elliptical, capsule-shaped, and egg-shaped cross-sections. Because the substantially oblong curvilinear cross-section increases the surface area at the surface of conductor 12 over a conventional cylindrical conductor, the skin effect is minimized because more current flows along the larger surface. As a result, the attenuation of coaxial cable 10 is improved since the overall resistance of conductor 12 is decreased.

In addition, in conventional approaches to improving the attenuation of coaxial cables, larger cylindrical conductor diameters are used to compensate for the increase in resistance at higher frequencies. Larger inner conductor diameter sizes typically require larger volumes of dielectric surrounding the conductor to maintain desired cable impedance. This increases the overall size of the cable and prevents the cable from being used with standard micro-connectors used in high frequency systems. The substantially oblong curvilinear cross-section of conductor 12 allows coaxial cable 10 to be used with existing cable connectors. In particular, conductor 12 permits a larger thousand circular mils (MCM) gauge equivalent conductor to fit into the height space restrictions of existing micro-connectors. The larger gauge conductor 12 also demonstrates better electrical performance (e.g., improved eye opening) due to improved rise time degradation characteristics.

Dielectric sheath 14 is formed around conductor 12 to provide insulation between conductor 12 and metallic shield 16. The thickness of dielectric sheath 14 is adjustable to control the impedance of coaxial cable 10, since the thickness of dielectric sheath 14 controls the spacing between conductor 12 and metallic shield 16. In one embodiment, dielectric sheath 14 is extruded over conductor 12. In another embodiment, dielectric sheath 14 is a tape or wrap made of a dielectric material. Exemplary materials that may be used for dielectric sheath 14 include polyvinyl chloride (PVC), fluoropolymers including perfluoroalkoxy (PFA), fluorinated ethylene propylene (FEP), and foamed fluorinated ethylene propylene (FFEP), and polyolefins such as polyethylene (PE), foamed polyethylene (FPE), polypropylene (PP), and polymethyl pentane. In an alternative embodiment, dielectric sheath 14 may comprise a dielectric tube and a solid core filament spacer to define an air core surrounding conductor 12, such as that shown and described in U.S. Pat. No. 6,849,799, assigned to 3M Innovative Properties Company, St. Paul, Minn., which is herein incorporated by reference.

Metallic shield 16 is formed around dielectric sheath 14 to shield conductor 12 from producing external electromagnetic interference (EMI). Metallic shield 16 also helps to prevent signal interference from electromagnetic and electrostatic fields outside of coaxial cable 10. Furthermore, metallic shield 16 provides a continuous ground for coaxial cable 10. In one embodiment, the interior surface of metallic shield 16 is an equal distance d from conductor 12 around the entire periphery of conductor 12. This results in even current distribution around the surface of conductor 12 (i.e., prevents current bunching), thus improving the attenuation of coaxial cable 10. Metallic shield 16 may have a variety of configurations, including a metallic braid, a served shield, a metal foil, or combinations thereof.

Jacket 18 is formed around metallic shield 16 and provides a protective coating for coaxial cable 10 and support for the components of coaxial cable 10. Jacket 18 also insulates the components of coaxial cable 10 from external surroundings. When jacket 18 is formed around metallic shield 16, outer surfaces 26 and 28 are substantially planar and parallel with surfaces 22 and 24 of conductor 12. Coaxial cable 10 has a low profile in that the distance between surfaces 26 and 28 is less than the distance between the curved outer surfaces of coaxial cable 10. This low profile allows coaxial cable 10 to be used in applications having confined spaces or minimal amounts of extra space. Jacket 18 may be made of a flexible rubber material or a flexible plastic material, such as PVC, to permit installation of coaxial cable 10 around obstructions and in tortuous passages. Other materials that may be used for jacket 18 include ethylene propylene diene elastomer, mica tape, neoprene, polyethylene, polypropylene, silicon, rubber, and fluoropolymer films available under the trade names TEFLON and TEFZEL from E. I. du Pont de Nemours and Company.

FIG. 3 is a cross-sectional view of a coaxial cable 30 including a drain wire 32 according to another embodiment of the present invention. Coaxial cable 30 also includes conductor 12, dielectric sheath 14, metallic shield 16, and jacket 18, as was shown and described with regard to coaxial cable 10 in FIGS. 1 and 2. Drain wire 32 is positioned outside of dielectric sheath 14, and metallic shield 16 surrounds and is in contact with drain wire 32 and dielectric sheath 14. In an alternative embodiment, drain wire 32 may be placed outside of and in contact with metallic shield 16. Jacket 18 is formed around metallic shield 16 and provides a protective coating for coaxial cable 30 and a support structure for the elements of coaxial cable 30.

Drain wire 32 is in electrical contact with metallic shield 16. Drain wire 32 controls the impedance of coaxial cable 30 by providing a means for electrical connection of metallic shield 16 to a connector. Drain wire 32 may be made of various conductive materials, including bare copper, tinned copper, copper-covered steel, or aluminum. Also, drain wire 32 may be either a stranded or a solid element. In the case of a stranded element, drain wire 32 is made of a plurality of electrically engaged conductive strands.

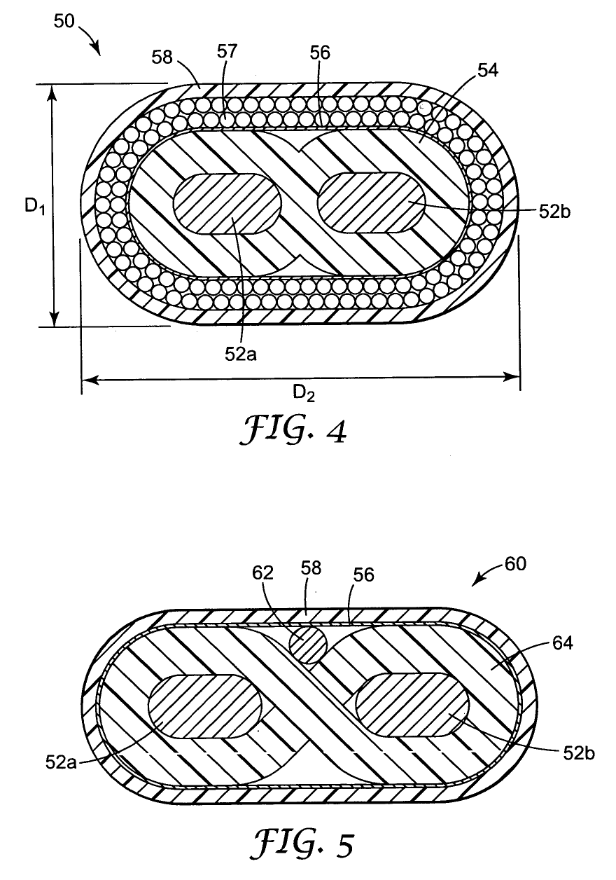

FIG. 4 is a cross-sectional view of twinaxial cable 50 according to another embodiment of the present invention. Twinaxial cable 50 includes conductors 52a and 52b, unitary dielectric sheath 54, metal foil 56, metallic wire shield 57, and jacket 58. Dielectric sheath 54 is formed around conductors 52a and 52b so as to generally surround conductors 52a and 52b. Metal foil 56 is formed around dielectric sheath 54 so as to generally surround dielectric sheath 54, and metallic wire shield 57 surrounds metal foil 56. Jacket 58 envelops metallic wire shield 57 to form an outer protective casing for twinaxial cable 50.

Conductors 52a and 52b may be made of various conductive materials, including bare copper, tinned copper, copper-covered steel, or aluminum. Also, conductors 52a and 52b may be either a stranded or a solid element. In the case of a stranded element, each conductor is made of a plurality of electrically engaged conductive strands. In one embodiment, conductors 52a and 52b are positioned relative to each other such that major axes of the substantially oblong curvilinear cross-sections of conductors 52a and 52b are coplanar (as shown in FIG. 4).

Twinaxial cable 50 is used in high frequency signal applications, such as those greater than 100 MHz. As described above, to minimize the skin effect, it is desirable to maximize the surface area of each conductor at the conductor surface. To increase the surface area over conventional cylindrical conductors, conductors 52a and 52b each have a substantially oblong curvilinear cross-section. A substantially oblong curvilinear cross-section includes any elongated shape having rounded sides including, but not limited to, ovate, elliptical, capsule-shaped, and egg-shaped cross-sections. Because the substantially oblong curvilinear cross-section increases the surface area at the surface of conductors 52a and 52b over conventional cylindrical conductors, the skin effect is minimized since more current flows along the larger surface. As a result, the attenuation of twinaxial cable 50 is improved since the overall resistance of conductors 52a and 52b is decreased.

In addition, in conventional approaches to improving attenuation, larger cylindrical conductor diameters are used to compensate for the increase in resistance at higher frequencies. Larger conductor diameter sizes typically require larger volumes of dielectric surrounding the conductor to maintain desired cable impedance. This increases the overall size of the cable and prevents the cable from being used with standard micro-connectors used in high frequency systems. The substantially oblong curvilinear cross-sections of conductors 52a and 52b allow twinaxial cable 50 to be used with existing cable connectors. In particular, conductors 52a and 52b permit larger thousand circular mils (MCM) gauge equivalent conductors to fit into the height space restrictions of existing micro-connectors. The larger gauge conductors 52a and 52b also demonstrate better electrical performance (e.g., improved eye opening) due to improved rise time degradation characteristics.

Dielectric sheath 54 is formed around conductors 52a and 52b to provide insulation between conductors 52a and 52b and metal foil 56. In one embodiment, dielectric sheath 54 is extruded over conductors 52a and 52b. The thickness of dielectric sheath 54 is adjustable to control the impedance of coaxial cable 10, since the thickness of dielectric sheath 54 controls the spacing between conductors 52a and 52b and metal foil 56. The orientation of and spacing between conductors 52a and 52b, which can also have an effect on the impedance of twinaxial cable 50, may also be controlled by the extrusion of dielectric sheath 54 over conductors 52a and 52b. Exemplary materials that may be used for dielectric sheath 54 include polyvinyl chloride (PVC), fluoropolymers including perfluoroalkoxy (PFA), fluorinated ethylene propylene (FEP), and foamed fluorinated ethylene propylene (FFEP), and polyolefins such as polyethylene (PE), foamed polyethylene (FPE), polypropylene (PP), and polymethyl pentane. In an alternative embodiment, dielectric sheath 54 may comprise a dielectric tube and a solid core filament spacer to define an air core surrounding conductors 52a and 52b, such as that shown and described in U.S. Pat. No. 6,849,799.

Metal foil 56 and metallic wire shield 57 are formed around dielectric sheath 54 to shield conductor 12 from producing external EMI. Metal foil 56 and metallic wire shield 57 also help to prevent signal interference from electromagnetic and electrostatic fields outside of twinaxial cable 50. The combination of metal foil 56 and metallic wire shield 57 provides excellent shielding properties. Furthermore, metal foil 56 and metallic wire shield 57 provide a continuous ground for twinaxial cable 50. Metal foil 56 may be comprised of a material such as copper and copper alloys. Metallic wire shield 57 may be comprised of a braided copper or copper alloys.

Jacket 58 is formed around metallic wire shield 57 and provides a protective coating for twinaxial cable 50 and support for the components of twinaxial cable 50. Jacket 58 also insulates the components of twinaxial cable 50 from external surroundings. Twinaxial cable 50 has a low profile in that the distance D₁ between the planar surfaces of twinaxial cable 50 is less than the distance D₂ between the curved outer surfaces of twinaxial cable 50 (see FIG. 4). This low profile allows twinaxial cable 50 to be used in applications having confined spaces or minimal amounts of extra space. Jacket 58 may be made of a flexible rubber material or a flexible plastic material, such as PVC, to permit installation of twinaxial cable 50 around obstructions and in tortuous passages. Other materials that may be used for jacket 58 include ethylene propylene diene elastomer, mica tape, neoprene, polyethylene, polypropylene, silicon, rubber, and fluoropolymer films available under the trade names TEFLON and TEFZEL from E. I. du Pont de Nemours and Company.

FIG. 5 is a cross-sectional view of twinaxial cable 60 according to another embodiment of the present invention including drain wire 62 and dielectric sheath 64 wrapped around conductors 52a and 52b. Twinaxial cable 60 also includes metallic shield 56 and jacket 58, as was shown and described with regard to twinaxial cable 50 in FIG. 4. Drain wire 62 is positioned outside of dielectric sheath 64 between dielectric sheath 64 and metallic shield 56. Metallic shield 56 surrounds and is in contact with drain wire 62 and dielectric sheath 64. In an alternative embodiment, drain wire 62 may be placed outside of and in contact with metallic shield 56. Jacket 58 is formed around metallic shield 56 and provides a protective coating for twinaxial cable 60 and a support structure for the elements of twinaxial cable 60.

Dielectric sheath 64 is taped or wrapped around conductors 52a and 52b to provide insulation between conductors 52a and 52b and metallic shield 56. Dielectric sheath 64 also controls the spacing between metal foil 56 and conductors 52a and 52b, the spacing between conductors 52a and 52b, and the orientation of conductors 52a and 52b. Because all of these parameters have an effect on the impedance of twinaxial cable 60, the impedance can be controlled by adjusting the thickness of dielectric sheath 64 and the orientation of conductors 52a and 52b held by dielectric sheath 64. Alternatively, dielectric sheath 64 may be extruded over conductors 52a and 52b, similar to dielectric sheath 54 in FIG. 4. Exemplary materials that may be used for dielectric sheath 64 include polyvinyl chloride (PVC), fluoropolymers including perfluoroalkoxy (PFA), fluorinated ethylene propylene (FEP), and foamed fluorinated ethylene propylene (FFEP), and polyolefins such as polyethylene (PE), foamed polyethylene (FPE), polypropylene (PP), and polymethyl pentane. In an alternative embodiment, dielectric sheath 64 may comprise a dielectric tube and a solid core filament spacer to define an air core surrounding conductors 52a and 52b, such as that shown and described in the previously incorporated U.S. Pat. No. 6,849,799.

In summary, shielded cable designers generally want to use as large an inner conductor diameter as possible since signal loss varies inversely with increasing conductor diameter. Larger inner conductor diameter sizes in transmission cables typically require larger volumes of dielectric surrounding the conductor to maintain desired cable impedance. This not only increases the overall size of the cable, but also prevents the cable from being used with standard micro-connectors used in high frequency systems. The present invention is a low profile transmission cable for high frequency applications that addresses these and other issues. The transmission cable includes one or more inner conductors each having a substantially oblong curvilinear cross-section. A dielectric material generally surrounds the one or more inner conductors. A metallic outer shield generally surrounds the dielectric material. An outer jacket envelops the metallic outer shield.

Although the present invention has been described with reference to preferred embodiments, workers skilled in the art will recognize that changes may be made in form and detail without departing from the spirit and scope of the invention.

1. A low profile transmission cable for high frequency applications, the transmission cable comprising:
one or more inner conductors each having a substantially oblong curvilinear cross-section;
a dielectric material generally surrounding the one or more inner conductors;
a metallic outer shield generally surrounding the dielectric material; and
an outer jacket enveloping the metallic outer shield;
wherein the major axes of the substantially oblong curvilinear cross-section of the one or more inner conductors lie in a single plane.

2. The transmission cable of claim 1, wherein the dielectric material comprises a unitary sheath extruded over the one or more inner conductors.

3. The transmission cable of claim 1, wherein the dielectric material is wrapped around the one or more inner conductors.

4. The transmission cable of claim 1, wherein the at least one of the one or more inner conductors comprises a unitary filament.

5. The transmission cable of claim 1, wherein at least one of the one or more inner conductors comprises a plurality of electrically engaged conductive strands.

6. The transmission cable of claim 1, wherein an inner surface of the metallic outer shield is generally equidistant from the one or more inner conductors.

7. The transmission cable of claim 1, wherein the metallic outer shield comprises a plurality of braided wires.

8. The transmission cable of claim 1, wherein the metallic outer shield comprises a foil layer.

9. The transmission cable of claim 1, wherein the metallic outer shield comprises a plurality of braided wires and a foil layer.

10. The transmission cable of claim 1, and further comprising:
a drain wire in electrical contact with the metallic outer shield.

11. (canceled)

12. A low profile transmission cable suitable for transmission of signals in excess of 100 MHz, the transmission cable comprising:
a first conductor having a first substantially oblong cross-section;
a first dielectric sheath generally surrounding the first conductor;
a metallic outer shield generally surrounding the dielectric sheath; and
an outer jacket enveloping the metallic outer shield.

13. The transmission cable of claim 12, wherein the metallic outer shield generally surrounds the dielectric sheath such that an inner surface of the metallic outer shield is generally equidistant from the first conductor.

14. The transmission cable of claim 12, and further comprising:
a second conductor having a second substantially oblong cross-section; and
a second dielectric sheath generally surrounding the second conductor;
wherein the first conductor and the second conductor are positioned such that a major axis of the first substantially oblong cross-section is generally coplanar with a major axis of the second substantially oblong cross-section.

15. The transmission cable of claim 14, wherein the first dielectric sheath and the second dielectric sheath are integral.

16. The transmission cable of claim 15, wherein the first dielectric sheath and the second dielectric sheath are extruded over the first and second conductors.

17. The transmission cable of claim 15, wherein the first dielectric sheath and the second dielectric sheath are formed by wrapping a dielectric material around the first and second conductors.

18. (canceled)

19. The transmission cable of claim 14, wherein the metallic outer shield generally surrounds the first dielectric sheath and the second dielectric sheath.

20. The transmission cable of claim 14, and further comprising:
a drain wire in electrical contact with the metallic outer shield.
